(19) United States
(12) Patent Application Publication
(10) Pub. No.: US 2010/0194358 A1
(43) Pub. Date: Aug. 5, 2010

(54) Standby Power Consumption Limiting Device

(75) Inventor: Andrew James Stanford-Clark, Chale (GB)

Correspondence Address: Nguyen & Tarbet, 6039 E. Grant Rd., Tucson, AZ, 85712, US

(73) Assignee: Eco Technology Corporation, Seychelles (GB)

(21) Appl. No.: 12/599,178

(22) PCT Filed: Apr. 25, 2008
(86) PCT No.: PCT/GB08/50296

§ 371 Date: Nov. 6, 2009

(30) Foreign Application Priority Data
May 9, 2007 (GB) 0708900.6

(51) Int. Cl. G05F 1/10

(52) U.S. Cl. 323/234

(57) ABSTRACT

A standby power consumption limiting device is provided for connection between an electricity supply and an electrical appliance of the kind having a main on/off switch, two power supply input terminals and a standby mode control circuit operable, when the appliance is switched “on”, to place the appliance in a reduced power standby mode. The device comprises standby mode detection means (102,103) effective to detect and indicate that the appliance has gone into standby mode and power switching means (104) having a first state in which the electricity supply is connected to the appliance via its power supply input terminals and a second state in which the electricity supply is disconnected from the appliance. A power switch control means (107) responds to an indication from the standby mode, by switching the power switching means from its first state to its second state, thereby removing power from the appliance. At this point, a test signal generating means (105), connected to one of the appliance input terminals by the power switching means when in its second state, generates a test signal of predetermined form, said test signal being returned, while the appliance main switch is in the “on” state, via the other appliance input terminal. A test signal detection means (106), connected to said other appliance input terminal by the power switching means when in its second state, is capable of detecting the test signal returned via said other terminal, when the appliance main switch is in its “on” state and of detecting a predetermined change in the returned test signal indicative of the appliance main switch having been turned to its “off” state. The power switch control means is responsive to an indication from the test signal detection means that the appliance main switch has turned been turned “off” to put the power switching means back into its first state thereby restoring power to the appliance which will then become active when its power switch is returned to the on position.

### FIELD OF THE INVENTION

The present invention relates to devices for limiting power consumption and, in particular, to devices for turning off the power supply to an electrical appliance operating in standby mode.

### BACKGROUND OF THE INVENTION

Many electrical appliances, for example televisions and other household appliances, have both an active, fully powered, mode of operation and one or several power saving modes, known as standby modes. In a standby mode, the appliance consumes significantly less power than when it is fully active. In the case of a television, the standby mode is typically initiated by operation of a remote control by the user as an alternative to switching the device off at the supply. Full operation can be resumed quickly by operation of the remote control.

In the case of a television, both picture display and sound system will be off in standby mode but the infra-red detector for sensing signals from the remote control will remain powered, as may other background functions, such as a clock display.

Timed appliances like washing machines and dishwashers, while not having an explicitly selectable standby mode, effectively enter a standby state after the washing cycle has finished. In this state user interface LEDs and the appliance microprocessor are still powered, awaiting user operation of the controls. It is frequently the case that such appliances are left on when they are not in use, for example when the cycle finishes during the night. Some standby current is thus being drawn.

Although standby power levels are considerably lower than fully active power levels, leaving the device permanently on in standby mode means that the total energy consumed in standby mode during the product lifetime can easily exceed that consumed in active operation.

In order to cut overall personal and national electricity consumption, it is frequently suggested that such appliances be turned off fully by means of a main on/off switch or at the power socket. Despite these exhortations, people either forget or are unwilling to take such actions. For this reason, several devices have been marketed or proposed in recent years which would operate automatically to turn off the power supply to an appliance left in standby mode. These fall into two categories:

1. devices which monitor the current consumption of an appliance, such as a computer, and turn off other related appliances, such as monitor, scanner, printer and modem, when the main appliance is turned off by a user. One such device, known as the “Intelliplug” ™ is a product of OneClick Technologies Limited and the subject of patent applications WO03048911 and WO2006136812.
2. devices which detect that an appliance has been placed into standby mode, for example by current monitoring or by detecting the user command from a remote control, and then turn the appliance off automatically.

In both cases, a user action is required to restore power. In the first case, the computer itself remains in powered standby mode and can be operated to initiate restoration of power to the peripherals. In the second case, as the appliance main on/off switch is already in the “on” state, so that the option for a straightforward switching back “on” of the appliance does not exist, an additional external stimulus, such as an infra-red or radio signal, to the standby limiting device, is required in order to reconnect the power supply to the appliance.

Various proposals have been made for devices of the second type. One of these is a product known as the “STANDBY-saver” which has been partially described on the website http://www.standby-saver.co.uk. This is a multi socket device which reduces power consumption to zero in response to operation of the standby button of the TV or audio system remote control. Although the website does not describe the product in detail, the Standby-saver has been the subject of a television programme “Dragons' Den” broadcast on BBC2 on Mar. 22, 2007 in which it was stated that the socket device includes a rechargeable battery which powers an infra-red detector on the socket when power to the appliance is disconnected. This responds to a signal from the appliance remote control to restore power; subsequent to which, a second operation of the remote control may be required to operate the appliance.

An abstract of Chinese patent application CN1753258 describes a “standby no electricity consumption remote controller socket” which can switch off the power supply of an electric appliance when in a standby state for over 30 seconds. Power supply is resumed “by remote switch” but the detail is not apparent.

Another approach is described in published patent application GB2430555 A for an “Electrical Connection Circuit” which shows using detection of a drop in standby mode current over a short period of time to isolate an appliance completely by means of a switched triac. The triac may be reset, to permit the device to be re-powered, either by temporarily disconnecting the power supply at the socket or by means of a manual reset button on the device. In its preamble, the application also mentions an alternative of resetting the isolating means in response to toggling of the ON/OFF switch of the appliance but does not describe how this may be achieved. This application is believed to describe another prototype device, known as the “Standby Plug” which is the subject of the website http://www.standbyplug.com.

### DISCLOSURE OF INVENTION

The prior art therefore either does not describe a convenient mechanism for restoring power after a standby supply has been automatically turned off. The proposed solutions either require the use of a remote control and corresponding sensor in the device, as in the Standby-Saver device, or require the user to operate either the mains power supply switch or a reset button on the device, as in GB2430555 A.

According to the present invention, there is provided a standby power consumption limiting device for connection between an electricity supply and an electrical appliance of the kind having a main on/off switch, two power supply input terminals and a standby mode control circuit operable, when the appliance is switched “on”, to place the appliance in a reduced power standby mode; the device comprising: standby mode detection means effective to detect and indicate that the appliance has gone into standby mode; power switching means having a first state in which the electricity supply is connected to the appliance via its power supply input terminals and a second state in which the electricity supply is disconnected from the appliance; power switch control means, responsive to an indication from the standby mode detection means that the appliance has gone into standby mode, to switch the power switching means from its first state to its second state, thereby removing power from the appliance; test signal generating means, connected to one of the appliance input terminals by the power switching means when in its second state, for generating a test signal of predetermined form, said test signal being returned, while the appliance main switch is in the “on” state, via the other appliance input terminal; and test signal detection means, connected to said other appliance input terminal by the power switching means when in its second state, capable of detecting the test signal returned via said other terminal, when the appliance main switch is in its “on” state and of detecting a predetermined change in the returned test signal indicative of the appliance main switch having been turned to its “off” state, the power switch control means being responsive to an indication from the test signal detection means that the appliance main switch has turned been turned “off” to put the power switching means back into its first state thereby restoring power to the appliance.

It will be realised that the test signal, as returned via the other appliance terminal, may be somewhat modified in form as a result of passage through the appliance.

The invention enables power restoration, simply in response to operation of the appliance on/off switch and does not require a more costly remote control arrangement communicating with the device. Nor does it require backup batteries. This is not only a cheaper solution but also overcomes the problem that the device, if it is a plug or socket, is unlikely to be easily manually accessible or have line of sight visibility to a remote control signal. Thus this invention not only eliminates the standby current of such appliances, by turning the appliance off after it has been placed in standby mode, but also enables the easy restoration of power when someone wants to use the appliance again. It will be realised that, when the power switching means is switched back to its first state, thereby restoring the power connection, the appliance switch will then be in the “off” position and will therefore need switching to the “on” position to render the appliance operational again.

It will also be obvious that, although the appliance standby current is eliminated by the invention, the device itself does require a very small amount of power in order to function, even when the appliance is completely powered down. However, this is significantly less than would be consumed by the appliance in standby mode.

Although the preferred form of power switching means is a double-pole double throw relay, it should be realised that a single pole relay may suffice, operative on only one of the input terminals.

Preferably and most conveniently, the standby mode detection means is arranged to monitor current supplied to the appliance. However, it could also be made responsive to a remote control signal, placing the appliance into standby mode or to some other indication of standby mode from the appliance itself but this would require extra connections.

With the current monitoring option, it is preferred that the standby mode detection means is arranged to indicate that the appliance has gone into standby mode after the monitored appliance current has remained below a predetermined threshold value for a predetermined time. This is in order to allow the change in state to stabilise and to give an opportunity to stop the power switching off if, for example, the remote control standby button has been pressed by mistake.

Although many of the functions of the device could be built as special purpose circuitry, it will be recognised that several of them can be most conveniently provided using a programmable controller. Where the power switching device is a relay, this can include relay control signal generating means in the controller for generating a relay control signal and a relay driver circuit for amplifying or otherwise transforming the relay control signal and applying it to the relay.

Also, such a controller will preferably include the test signal generating means and test signal detection means, with protection circuits for limiting the test signals to and from the appliance being provided externally.

Whatever the form of the test signal generating means, its operation is preferably delayed, after the power switching means is switched to its second state, until the return test signal has stabilised. The predetermined change detected by the test signal detection means is preferably the absence of the return test signal or its level falling below a predetermined threshold. Alternatively, the signal's waveform could change to a predetermined new shape.

It is preferred that, as a backup, the device should include over-ride means, such as a push button, for ignoring the test signal detection means and supplying an alternative input to the relay control means to cause it to switch the relay back to its first state to restore power to the appliance.

The device may be embodied as an adapter located between a supply socket and the appliance plug, a plug for the appliance power lead, an extension lead with the device located between the plug and the trailing socket, or a power supply socket. In the latter case, a further preferred feature would be an additional switch on the socket for enabling or disabling the standby current limiting components in order to permit normal standby operation of the appliance with the device in its disabled state.

### BRIEF DESCRIPTION OF DRAWINGS

The invention will now be described, by way of example only, with reference to a preferred embodiment thereof as illustrated in the accompanying drawings, in which:

FIG. 1 is a block diagram showing the arrangement of the main components of a standby power consumption limiting device for an appliance, according to the invention;

FIG. 2 is a flow diagram showing the steps carried out by the device of FIG. 1 in detecting the standby state of the appliance;

FIG. 3 is a flow diagram showing the steps carried out by the device of FIG. 1 in the disconnection from and restoration of power to the appliance; and

FIG. 4 shows waveforms (not to scale) representing signals occurring in the device of FIG. 1 during operation.

### DETAILED DESCRIPTION OF THE INVENTION

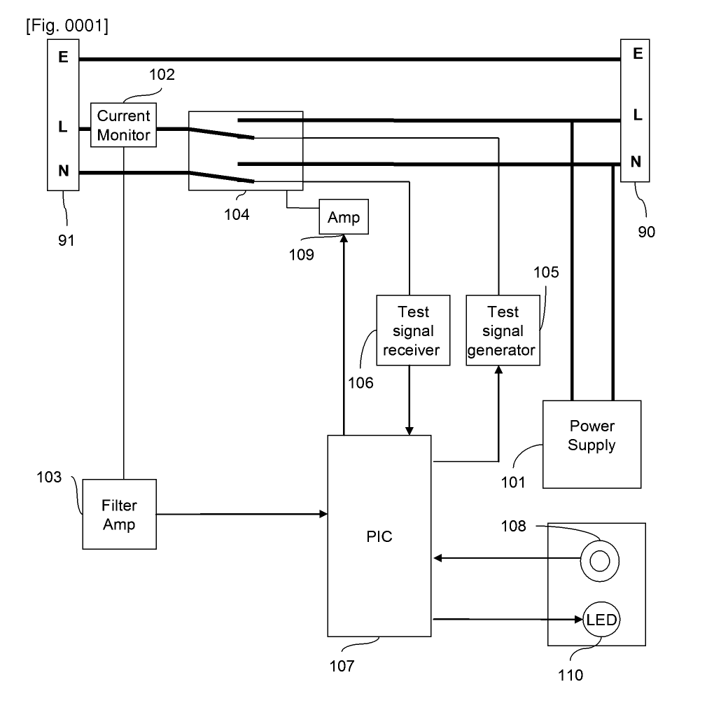

FIG. 1 shows a standby power consumption limiting device in the form of an adapter interposed between an electricity supply outlet 90 and the input terminals 91 or plug connection of an electrical appliance (not shown) which is capable of going into a standby power mode of operation. The power supply is assumed to be a single phase supply, having Live (L), Neutral (N) and Earth (E) connections. An AC voltage is supplied between the Live and Neutral terminals. In normal operation of the appliance, power from outlet 90 is connected to appliance input terminals 91 via a double-pole double-throw relay 104 with its contacts held in a closed position, corresponding to a first state. The relay is held closed as long as a control signal from an amplifier 109 is provided.

Power for the standby power consumption limiting device is supplied by an auxiliary power supply 101 which takes mains AC and transforms and regulates it down to the (generally) 5v DC needed to power other components of the device. Such power supplies are well known and typically include a DC-blocking capacitor, a high wattage resistor, a smoothing capacitor, and a 5V regulator in order to produce a stable 5V DC supply (in another embodiment, a Zener diode might be used). The power consumption of such a power supply is insignificant compared with the standby power consumption of the appliance, for example, 0.3W.

Connected into the live (L) pathway (though it could equally well be on the neutral side) is a current monitoring means 102, which together with a filter and amplifier 103, detects when the appliance has gone into the standby mode. The current monitoring means includes a conventional arrangement (not illustrated) of a shunt resistor with a low resistance (for example, 1 Ohm), in series with the appliance, or, alternatively, a toroidal transformer wrapped around one of the supply wires to the appliance. Other current or power monitoring devices which may be used include a Hall-effect measuring device.

The filter and amplifier 103 takes the signal from the current monitoring means 102 and filters it to protect the remaining electronics from high voltage transients, using surge arrestors and Zener “clamp” diodes. An operational amplifier then amplifies the small signal received from the current monitoring means 102 into a signal that can be processed by a microcomputer unit 107.

The microcomputer is an embedded microcontroller device, such as a PIC (programmable interface controller) which has a number of digital input sensing pins, a number of analogue-to-digital converter inputs, a number of digital output control pins, a non-volatile storage capability (ROM, or EEPROM), volatile storage capability (RAM), and an instruction processing capability (CPU).

The output of filter amplifier 103 is an A/C waveform, with amplitude proportional to the current being used by the appliance. This is fed into the Analogue to Digital converter input of the microcomputer 107, where it is rectified or similarly filtered in software, and smoothed to generate an average value of a large number of readings.

Connection and disconnection of the electricity supply outlet 90 from the appliance power input is effected by a power switching means, comprising the double-pole double throw relay 104, in response to the presence or absence of a digital relay control signal from the microcomputer 107. The digital control signal is amplified by amplifier 109 to provide the necessary control signal to relay 104. When the microcomputer 107 detects that the appliance current has fallen to standby levels, by monitoring the output of filter amplifier 103, it removes the digital control signal to amplifier 109 causing the relay 104 contacts to switch to the open position shown in FIG. 1.

Thus the device of FIG. 1 monitors the power consumption of the appliance, to detect when it changes from its “active” mode to its “standby” mode. After a short time delay, during which the appliance might possibly be put back into active mode again, if the appliance remains in standby mode, the device turns off the power to the appliance. At this point, the appliance is completely disconnected from the mains power, and consumes no energy.

The relay 104 has two roles—firstly, to switch the supply to the appliance on and off, as described, and, secondly, to connect a test signal generator 105 and test signal receiver 106 to the appliance. Note that these modes are mutually exclusive states—i.e. the appliance is either connected to the mains and is operable or it is disconnected from the mains and, instead, is connected to the signal generator 105 and receiver 106.

The purpose of the test signal generator 105 and test signal receiver 106 is to enable the microcomputer 107 to restore power to the appliance, after the standby power has been turned off, in response to an external stimulus, namely, the switching “off” of the appliance main switch.

In the diagram of FIG. 1, for ease of illustration, the signal generator 105 is shown as a separate component activated by microcomputer 107 to generate a regular pulsed signal to send into the appliance through its Live (L) input connection. This includes protection from high voltages which may exist in the appliance shortly after the moment of switch-over and is implemented using Zener “clamp” diodes and surge arrestors. However, in the preferred implementation, the function of signal generator 105 is split between the microcomputer and external circuitry so that the test signal itself is generated by the microcomputer, and the external circuit then just consists of the protection diodes and surge arrestor.

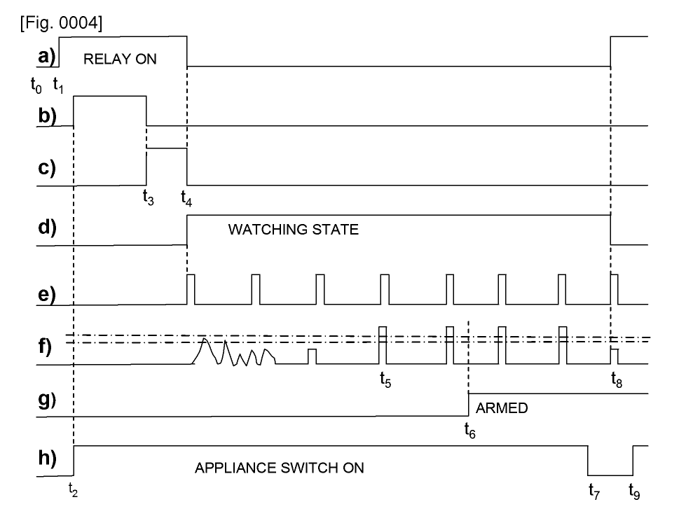

Either way, the signal generator function produces regular digital pulses of known width (e.g. 50 ms pulse every 250 ms), as illustrated in FIG. 4, waveform (e). These are preferably of amplitude 5 volts, nowhere near enough to activate the circuitry of the appliance which is expecting to see mains voltage (240 volts in the UK). However, the test signal will, in the case of many appliances, pass through the power supply circuitry of the appliance and will emerge, possibly somewhat modified, on the neutral wire.

The signal receiver 106, also shown as a separate component for ease of illustration, monitors the signal returning from the appliance via its Neutral (N) connection, when the relay 104 is switched to connect the signal generator 105 and the signal receiver 106 to the appliance. The signal receiver provides protection from high voltages which are present in the appliance shortly after the moment of switch-over. This is again implemented using Zener “clamp” diodes and surge arrestors. The function of signal receiver 106 is also to monitor the neutral line for low level (5v or less) pulses of approximately the width and frequency sent out by the signal generator 105 (e.g. 50 ms pulse every 250 ms) and to detect when they are absent or below a predetermined voltage or pulse width.

Detection that these pulses are absent, indicates that the appliance main power switch has been turned off, thereby interrupting the test signal loop. This is the signal which causes the microcomputer to initiate the restoration of power to the appliance. Again, in the preferred implementation, the function of signal receiver 106 is split between the microcomputer 107 and external circuitry so that the return signal analysis is performed by the microcomputer and the external circuitry reduces to protection diodes and surge arrestor in order to protect the microcomputer from damage.

Thus, to reiterate, the device of FIG. 1 operates by sending pulsed signals into the appliance through its main supply cable and monitoring the signal coming back from the appliance. For many appliances, even though power is removed, while the appliance is still turned on at its main power switch, a signal sent along the Live wire will be received back on the Neutral wire. When the user wishes to turn on the appliance again, they turn the appliance “off” then “on”, at the main switch. When the switch is turned off, for many appliances, the signal sent from the test signal generator 105 is interrupted and either cannot be received by receiver 106, or significantly changes its pattern. This change is detected by the device, which restores power to the appliance. Then, when the main switch on the appliance is turned back on, the appliance will turn on and function as usual.

As a backup against failure by detector circuit 106 to detect the appliance being switched to “off” or for use with appliances which do not have a main on/off power switch, a push button 108 is provided on the device to enable power to be restored manually. The push button is wired into a digital input of the microprocessor 107 and operation of the button causes the microprocessor to generate the digital control signal to amplifier 109 and reconnect power to the appliance by closing the relay 104.

The button is part of the user interface of the device which also includes a light emitting diode (LED) output device 110. The LED 110 is controlled by a digital output of the microcomputer 107 and indicates the actual powered state of the appliance. It is constantly on when the appliance is powered and flashing when the appliance is briefly in standby mode prior to all power being removed. When there is no power to the appliance, the LED is off. In an alternative implementation, the LED could flash slowly when there is no power to the appliance, indicating that the device is waiting for the appliance main power switch to be turned off then on again.

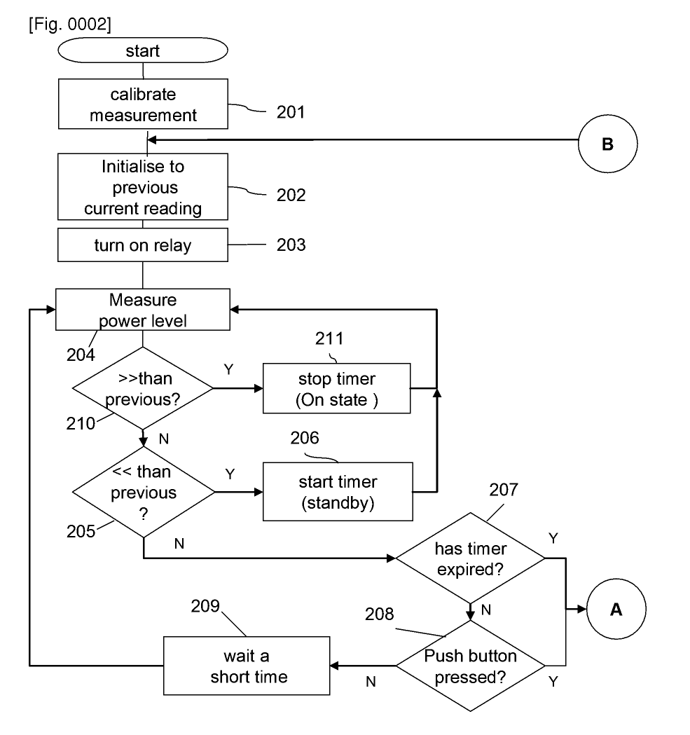

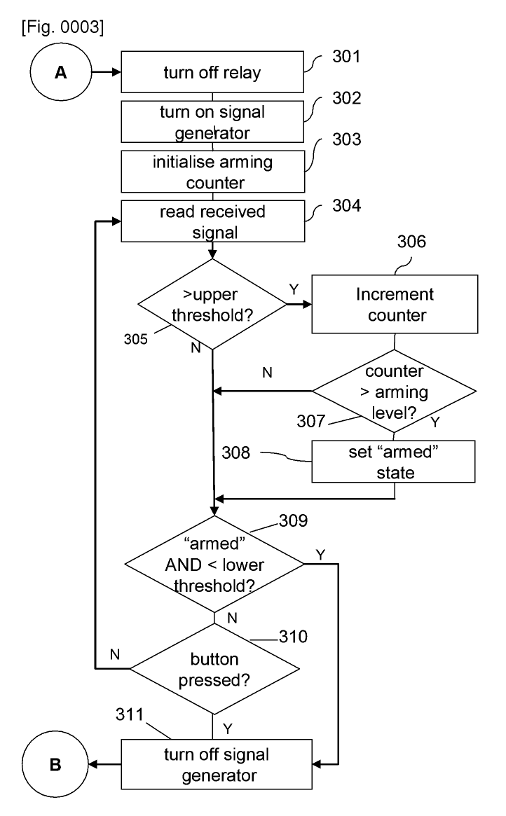

The operation of the device under control of microcomputer unit 107 is described in the flow charts of FIGS. 2 and 3, with reference to the waveforms of FIG. 4. The microcomputer controls the entire operation of the device, in response to stimuli from the current monitoring means 102 (via the filtering and amplification means 103), the signal receiver 106, and the push-button 108.

Firstly, when power is initially applied to the device, for example when it is plugged into a wall socket and the socket is turned on, the power switching relay 104 is set to disconnect the appliance from the supply outlet 90. With the signal generator 105 also off, the microcomputer, in step 201, initially calibrates the current measuring system (102 and 103) to establish the output voltage level from amplifier 103 corresponding to the “zero” level for current consumption. FIG. 4 shows the state of the relay and of the appliance switch in waveforms (a) and (h) during this initial calibration period t₀ to t₁. The zero level output of amplifier 103 is shown in waveform (b).

This calibration is stored, in step 202, as the “previous current reading” and the microcomputer next turns on the relay (step 203 and waveform (a)) at time t₁ to connect the power supply to the appliance. The appliance is then switched on at time t₂, as shown in waveform (h), and starts to draw current.

The current being drawn by the appliance, proportional to its power consumption, is next measured, in step 204, by rectification of the AC voltage level across the current monitor 102, as filtered by the filter/amplifier 103. Within the microcomputer 107, rectification is effected by examining each digitised value to see if it is “negative”, i.e. below the established zero line and, if it is, it is inverted so it is now above the zero line. The resulting value is then DC shifted (by subtracting the “zero” value) down to zero, so it can be averaged and compared with other values. The amplifier in 103 effectively DC shifts the AC waveform up to approximately the midpoint of the DC supply rails (i.e. around 2.5V for a 5V supply when the current is zero).

Then, in a repetitive loop, the microcomputer measures the current consumption, and compares it to the previous reading in steps 205 and 210.

Assuming the appliance switch is turned on at time t₂, current will be drawn and the measured power consumption will rise, as shown in waveform (b) of FIG. 4. If, after a period of use, the appliance remote control is operated to put the appliance into its standby mode, the measured current value significantly decreases at time t₃ and this is detected in step 205. In step 206 a timer is started, as shown in waveform (c), and, for a short period (approximately 30 seconds), terminating at time t₄, the appliance can be turned back on again. During this period, the LED indicator 110 flashes, to warn the user power is about to be switched off.

If the appliance is still in standby mode and the timer has expired, as determined in step 207, the microcomputer moves into a “watching” state, as shown in waveform (d). If the timer has not yet expired in “standby” mode, the microcomputer checks the push button, in step 208, to see if it has been pressed, indicating a user interface command to turn off standby power. If button 108 has been pressed, the system also moves into the “watching” state. If not, it pauses, in step 209, for a short time (preferably around 5 seconds) before going round the main loop again and returning to step 204.

If the measured current value did not decrease from the previous reading, as determined by step 205, step 210 then determines whether it has increased substantially. If so the appliance is recognised as being in the “on” state. It may have entered this state either from an “off” or a standby state. If the appliance was previously in standby mode, and the countdown timer was running, then the timer is stopped, in step 211, to prevent the device from turning off the appliance while it is still being used.

On entering the “watching” state, at time t₄, the microcomputer first turns off the relay 104, in step 301, disconnecting power from the appliance, and turning it fully off (zero current consumption by the appliance). In step 302, it then turns on the test signal generator function 105, either by means of a digital control signal to an external generator or by activating a signal generator function within the microcomputer unit itself. This produces a series of regular test pulses as shown in FIG. 4(e). At the same time, an “arming” counter is initialised to zero in step 303.

Next, in a loop, the microcomputer unit reads the width and frequency of the signals coming back from the signal receiver 106. If there is a clear path through the appliance power supply, the signal coming back will be quite similar to the signal being sent (possibly varying a little in amplitude and width, due to the components in the appliance that the signal has passed through). However, sometimes after the mains power has been disconnected, it may take some seconds for the signal to settle. This is taken into account by the microcomputer which looks for a repetitive, clear signal that is stable for a period of time (5 seconds, say), above some pre-determined upper threshold. It is then deemed to be “armed”. A possible form of the returned test signal is shown in FIG. 4(f) where it will be seen, in the period t₄ to t₅, that the signal is initially very unstable.

After initialising the arming counter, the received pulse signal is read (step 304), and a determination made, in step 305, as to whether it is above the pre-determined upper threshold (indicated by the upper alternate dot and dash line in FIG. 4(f)). If so, the counter is incremented in step 306. If the count is determined to be above an “arming level”, in step 307 (time t₆), then the return test signal is considered to have stabilised and the armed state is set in step 308. This is shown in waveform (g) of FIG. 4. If the counter has not reached the arming level, and if the received signal is below the upper threshold (indicated by the upper alternate dot and dash line in FIG. 4(f)) and the push button 108 has not been pressed (step 310), the process returns to step 304 and the tests are repeated on subsequent received signals.

If at some point after entering the “armed” state, at a time t₇, the received signal suddenly drops to a very low level, below the lower pre-determined threshold, then the microcomputer infers, in step 309, that the on/off switch of the appliance has been switched off, which is the indication that the user wishes to use the appliance again. In the case where the signal receiver 106 is unable to differentiate the two states of the on/off button of the appliance (which depends on the design of the power supply of the appliance, and the location of the power switch relative to the power supply in the appliance's internal circuitry), then the user has the option of pressing the push-button on the user interface (108) of the device to turn the appliance back on.

The upper and lower thresholds, employed in steps 305 and 309, provide a degree of hysteresis to give stability to the system.

At the point where it is detected that either (a) the signal injected into the appliance suddenly drops or (b) the push-button on the user interface (108) of the device is pushed, the unit turns off the signal generator (105) in step 311. This occurs upon arrival of the next test pulse at time t₈ which falls below the lower threshold. Control then returns to step 202 where the zero current output of amplifier 103 is recalibrated, as described above. Turning off the signal generator 105 is strictly not necessary but is desirable, as its continued operation could affect the calibration timing by the microprocessor. Operation of the appliance may then be resumed at time t₉ by turning it ON again at its main switch. In practice, the appliance would be switched OFF at time t₇ then almost immediately ON again, at time t₉. In fact, the switching on of the relay occurs, as shown in waveform (a) at time t₈, a short time period after the appliance is switched off at time t₇. This is because it is necessary to wait for a low or missing pulse to be detected in steps 304 and 309, at time t₉, before the operation of the appliance switch to its off state can be confirmed.

Although the above detailed description has assumed that the device is embodied in an adapter which plugs into a mains socket, and into which the appliance plugs, it will be realised that it could also be incorporated in a plug which is attached to the mains cable of the appliance in place of its existing plug, as part of an extension cable with a plug and trailing socket, or into the wall socket into which the appliance is plugged.

In the latter case of the wall socket, the user interface would have an additional switch, preferably a slide switch, which would allow the user to enable or disable the function provided by this invention, allowing the socket to behave normally when the function is turned off.

It should also be noted that the function of the push-button 108 in the user interface could be replaced or augmented by: (a) a remote push button on a wire which could be near the accessible front of the appliance, (b) a wireless remote control with a single push button, (c) a Bluetooth™ signal sent from a mobile phone to a receiver in the device, (d) a message sent over a wireless networking connection such as Zigbee (IEEE 802.15.4), Wifi (IEEE 802.11x), or (e) an infra-red or ultra-sonic command sent from a remote control device to a receiver in the device. Clearly these alternatives would be more complex and costly than the simple button.

Finally, it will be realised that the functions of the microcomputer programming could be converted to a hardware implementation using logic gates and discrete analogue components, if so desired. It is, however, more convenient in the preferred embodiment to make use of a programmable interface controller.

1. A standby power consumption limiting device for connection between an electricity supply and an electrical appliance of the kind having a main on/off switch, two power supply input terminals and a standby mode control circuit operable, when the appliance is switched “on”, to place the appliance in a reduced power standby mode; the device comprising:
standby mode detection means (102,103) effective to detect and indicate that the appliance has gone into standby mode;
power switching means (104) having a first state in which the electricity supply is connected to the appliance via its power supply input terminals and a second state in which the electricity supply is disconnected from the appliance;
power switch control means (107), responsive to an indication from the standby mode detection means that the appliance has gone into standby mode, to switch the power switching means from its first state to its second state, thereby removing power from the appliance;
test signal generating means (105), connected to one of the appliance input terminals by the power switching means when in its second state, for generating a test signal of predetermined form, said test signal being returned, while the appliance main switch is in the “on” state, via the other appliance input terminal; and
test signal detection means (106), connected to said other appliance input terminal by the power switching means when in its second state, capable of detecting the test signal returned via said other terminal, when the appliance main switch is in its “on” state and of detecting a predetermined change in the returned test signal indicative of the appliance main switch having been turned to its “off” state,
the power switch control means being responsive to an indication from the test signal detection means that the appliance main switch has turned been turned “off” to put the power switching means back into its first state thereby restoring power to the appliance.

2. A device as claimed in claim 1 in which the power switching means (104) is a double-pole double-throw relay.

3. A device as claimed in claim 2 including a programmable controller (107), the power switch control means including relay control signal generating means in the controller for generating a relay control signal and a relay driver circuit (109) for amplifying the relay control signal and applying it to the relay.

4. A device as claimed in claim 1 in which the standby mode detection means is arranged to monitor current supplied to the appliance.

5. A device as claimed in claim 4 in which the standby mode detection means is arranged to indicate that the appliance has gone into standby mode after the monitored appliance current has remained below a predetermined threshold value for a predetermined time.

6. A device as claimed in claim 1 including a programmable controller (107), the test signal generating means and test signal detection means forming part of the controller, the device further including protection circuits for limiting the test signals to and from the appliance.

7. A device as claimed in claim 1 in which the operation of the test signal detection means is delayed, after the power switching means is switched to its second state, until the return test signal has stabilised.

8. A device as claimed in claim 7 in which the predetermined change detected by the test signal detection means is the return test signal being absent or falling below a predetermined threshold.

9. A device as claimed in claim 1 further including override means (108) for ignoring the test signal detection means and supplying an alternative input to the relay control means to cause it to switch the relay back to its first state.

10. A device as claimed in claim 9 in which the over-ride means includes a push button (108) on the device.

11. A device as claimed in claim 1 which is an adapter connectable between an electricity supply socket and the power plug of the appliance.

12. A device as claimed in claim 1 which is a plug for the appliance.

13. (canceled)

14. A device as claimed in claim 1 which is an electricity supply socket.

15. A device as claimed in claim 14 which includes a further switch for enabling or disabling the device, to permit normal standby operation of the appliance with the device in its disabled state.
